(19) United States
(12) Patent Application Publication
(10) Pub. No.: US 2004/0268409 A1
(43) Pub. Date: Dec. 30, 2004

(54) System of dynamic video mode switching and method for transmitting the same

(76) Inventors: Yi-Lon Chin, Taipei (TW); Chang-Hung Lee, YunLin (TW)

Correspondence Address: BIRCH STEWART KOLASCH & BIRCH, PO BOX 747, FALLS CHURCH, VA, 22040-0747, US

(21) Appl. No.: 10/856,948

(22) Filed: Jun. 1, 2004

(30) Foreign Application Priority Data
Jun. 10, 2003 (TW) 092115619

(51) Int. Cl. H04N 7/173; H04N 7/16; H04N 7/18

(52) U.S. Cl. 725/116; 725/81; 725/131; 725/146; 348/613

(57) ABSTRACT

A system of dynamic video mode switching and a method for transmitting the same that, according to the communication environment detected by the detection parameter, the mode of the linear transmission won't be changed if the communication environment is good, and the redundant data generated by the image grabber is removed for reducing the volume of data transmitted and increasing the communicating distance of wireless transmission if the communicating circumstance is poor. In addition, other compress method may be adapted for cooperating with the present invention for further compressing the data.

### FIELD OF THE INVENTION

The present invention relates to a system of dynamic video mode switching and a method for transmitting the same, and more particularly, to a system and a transmitting method capable of reducing the volume of data transmitted by changing the number of still pictures per second fetched for forming a video and recovering the video to an original state.

### BACKGROUND OF THE INVENTION

Recently, following the progress of wireless communication, not only the craving for wireless communication of mankind is realized, but also the wired products had been gradually replaced by wireless ones, such that the traditional bondage may be removed, and the freedom of the user may further be extended.

However, “broadcasting” adapted in wireless communication for data transmission may cause many serious problems, one of which is the error rate of transmitted data. Due to the limitation of bandwidth and the high error rate, the development of the wireless transmission is slower and unstable comparing to the wired transmission. Especially for the video transmission having requirement of transmitting large amount of data, the development in wireless transmission is greatly restrained. The high error rate of data transmission not only makes transmitting side requiring a large amount of duplicated image data, but also makes communicating distance unable to be extended effectively. This is a very serious problem for current communicating products, which have a wireless trend.

Take an embodiment as example. Please refer to FIG. 1, which is a wireless framework of videoconference. A simple wireless videoconference system comprises two sets of videoconference unit 1, each further comprising: an image grabber 11 usually composed of charge coupled device (CCD) for fetching the image data; a processor 13 connected to the image grabber 1 for transmitting the data of fetched image after encoding thereof, and also decoding a transmitting signal 16 received from outside; a display 15 connected to the processor 15 for displaying the signal received and processed by the processor 15. Image data are transmitted between videoconference units wirelessly. Since the error rate of wireless transmission is high, the erroneous part requiring to be resent is consequentially high. In an embodiment, for every second of processing time, the processor will require 800 milliseconds for receiving and processing data, so there are only 200 milliseconds available for resending the erroneous data, that is, if the time for resending the erroneous data exceeds 200 milliseconds, the data will lose its integrity. Furthermore, the error rate is proportional to the distance, that is, the farther the distance is, higher the error rate will be. When error rate exceeds a specific level, e.g., 20% according to the aforesaid embodiment, it is impossible to show a complete image. Therefore, a long communicating distance will cause seriously influence on the practicability of a wireless videoconference.

Reducing the amount of data for transmitting is one method for solving the aforesaid problem, namely, the transmitted errors will be reduced. Therefore, in the processor, image data are often being compressed before sending out. However, in order to avoid too much distortion, although there are many kinds of compressing method available, there is still a limit for the compressibility. Therefore, a new system and method is needed for overcoming the aforesaid problems.

### SUMMARY OF THE INVENTION

The primary objective of the present invention is to provide a system of dynamic video mode switching and a method for transmitting the same capable of reducing the volume of data transmitted by wireless transmission.

The secondary objective of the present invention is to provide a system of dynamic video mode switching and a method for transmitting the same capable of increasing the communication distance of wireless transmission.

Another objective of the present invention is to provide a system of dynamic video mode switching and a method for transmitting the same capable of operating on cooperation with a compress method.

To fulfill the aforesaid objectives, the present invention provides a system of dynamic video mode switching for transmitting images using wireless transmission, the system comprising:

a transmitting end having a first converter, that a video signal received by the first converter will use a first video mode or a second video mode to covert the received video signal into a video-transmitting signal according to a detection parameter; and

a receiving end having a second converter, that the second converter receives the video-transmitting signal and thereafter converts the received video-transmitting signal into an output video signal, wherein the output video signal is in the first video mode;

wherein, the first video mode and the second video mode represent different numbers of still pictures per second for a video signal.

The present invention also provides a transmitting method for dynamic video mode switching adapted for a wireless video transmission system, the method comprising the steps of:

A: according a detection parameter, converting a video signal into a first video signal selectively by a first video mode and a second video mode, wherein the first video mode and the second video mode represent different numbers of still pictures per second;

B: according to the selected video mode, converting the first video signal by a first algorithm into a video-transmitting signal, the converting process may be compressing;

C: transmitting the video-transmitting signal.

Following drawings are cooperated to describe the detailed structure and its connective relationship according to the invention for facilitating your esteemed members of reviewing committee in understanding the characteristics and the objectives of the invention.

### BRIEF DESCRIPTION OF THE DRAWINGS

FIG. 1 is a wireless framework of a videoconference.

FIG. 2 is a framework of a traditional method.

FIG. 3 is a framework of the present invention.

FIG. 4 is a flowchart of the present invention.

FIG. 5 is an embodiment showing a wireless framework of a videoconference according to the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

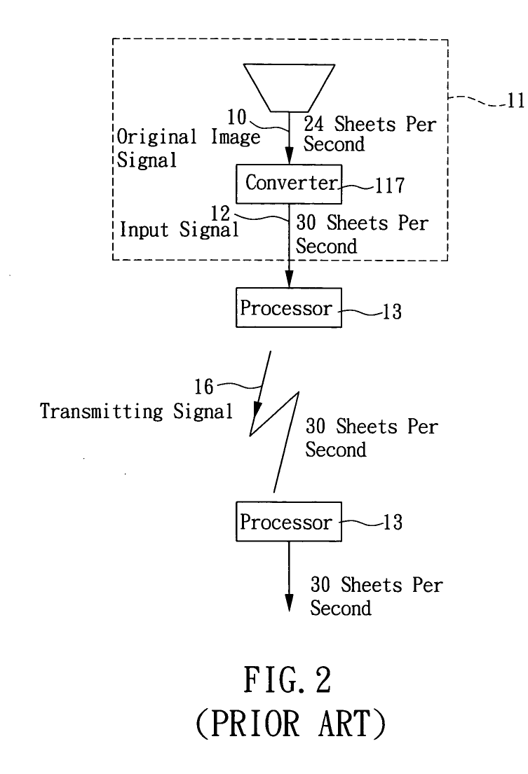

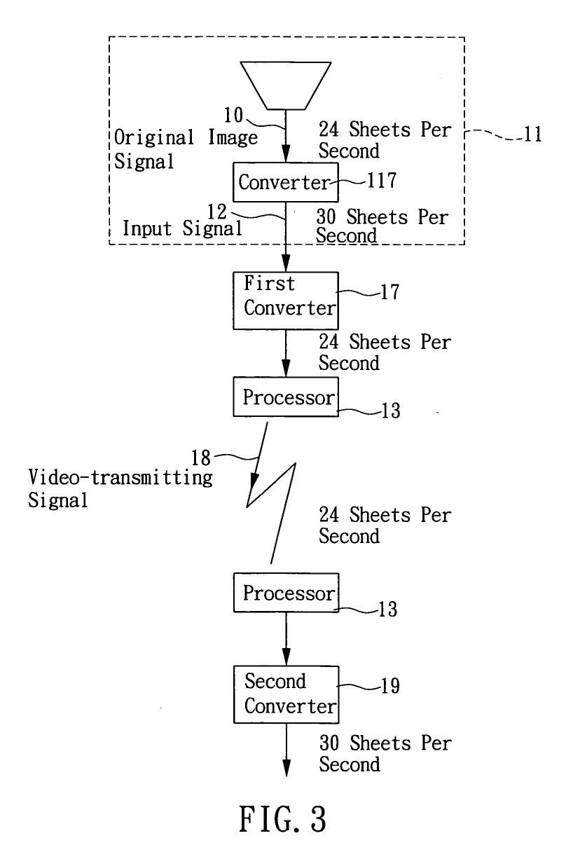

The spirit of the present invention is to remove redundant data so as to reduce the volume of transmission. Please refer to FIG. 2, which is an illustration of traditional method. As everyone knows, the so-called continuous animation is the constitution of multiple sheets of still picture that are played continuously and rapidly. A common camcorder uses a speed of 24 sheets of still picture per second for videotaping. When playing the video on the display, local power frequency must be taken into consideration to avoid asynchronous phenomenon. Taking the TV system in Taiwan for example, the NTSC (National Television System Committee) system is adapted in Taiwan, i.e., a power frequency of 60 HZ used in Taiwan requires a system broadcasting 30 sheets of still picture per second. Therefore, in order to play a video taken by a common camcorder of 24 sheets of still picture per second on Taiwan's NTSC system, a converter 117 must be applied to convert the original image signal 10 of 24 sheets per second into an input signal 12 of 30 sheets of still picture per second using a certain algorithm. However, the information contained in the processed input signal does not increased. The additional 6 sheets of picture are dependent to other 24 sheets of picture and are simply for synchronizing with the frequency. In the solving procedure of algebra, the dependent equations can be transformed into other dependent equations through algebra operation and is useless for getting the solution, thus, the dependent equation can be dropped from the equation set. Similarly, the 6 sheets of redundant picture can be removed from the transmission. Please refer to FIG. 3, which is the framework of the present invention. The present invention applies a first converter 17 to convert the input signal of 30 sheets of still picture per second into a transmitting signal of 24 sheets of still picture per second, afterward, the transmitting signal is sent out by wireless transmission. In such way, the objective of reducing the amount of data transmitted is accomplished.

The present invention provides a system of dynamic video mode switching and a method for transmitting the same capable of transmitting data in normal mode when the communication environment is good, and switching and transmitting data in reduction mode when the communication environment is poor, the system comprising: a transmitting end and a receiving end.

The transmitting end, which evaluates the communication environment according to a detection parameter for deciding which video mode is to use for transmit ting the video signal: common mode or original mode. In an embodiment, the detection parameter may be the error rate of the transmitted data, The communication environment is good when the error rate is smaller than a threshold such that the common mode may be adapted for transmission. The communication environment is poor when the error rate is larger than the threshold such that the amount of transmission data must be reduced that is, the data is transmitted using a reduction mode. After the transmitting mode is decided, next thing to do is using a first converter 17 to convert the input signal 12 into a video-transmitting signal 18 conforming to the format defined by the foregoing chosen transmitting mode according to certain specific algorithm. For example, in a NTSC system, when a common mode is used, a unit function is applied to keep the characteristic of the original data and then output the video-transmitting signal 18. On the other hand, when a reduction mode is applied, an algorithm is needed to convert the signal of 30 sheets of still picture per second into the signal of 24 sheets of still picture per second, and the converted video-transmitting signal 18 is then being sent out.

The receiving end having a second converter 19 is used to receive the video-transmitting signal 18 and apply an appropriate algorithm to recover the video-transmitting signal 18 of reduction mode into the format of a common mode. The transmitting end may emit a changing signal to notify the receiving end of working mode changing; on the other hand, the receiving end may automatically change the working mode directly according to the detection parameter. The receiving end is required to choose an appropriate inverse function of the algorithm used by the transmitting end so as to recover the received video-transmitting signal 18. That is, when the transmitting end of the NTSC system is in common mode, the second converter 19 will outputs the received signal directly without processing or the received signal may be recovered by an inverse function of the unit function and is then sent out. When it is a reduction mode, the receiving end will applies the inverse function of algorithm used by the transmitting end to recover the video-transmitting signal 18 in the mode of 24 sheets per second into the mode of 30 sheets per second.

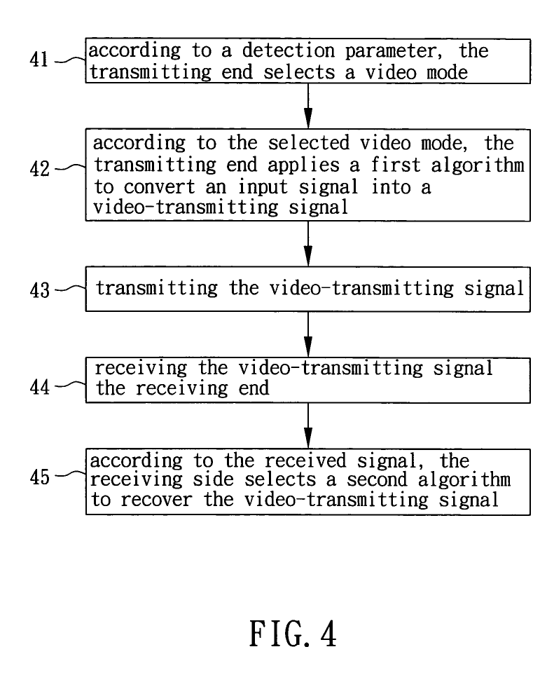

Please refer to FIG. 4, which is a flowchart according to the present invention. The invention provides a transmitting method of dynamic video mode switching applied in wireless image transmission, comprising the steps of:

step 41: according to a detection parameter, the transmitting end selects a first video mode or a second mode converting a video signal, wherein each video mode represents a number of still pictures per second in a continuous image.

step 42: according to the selected video mode, the transmitting end applies a first algorithm to convert the video signal into a video-transmitting signal whose format is defined by the video mode 18.

step 43: transmitting the video-transmitting signal 18.

step 44: receiving the video-transmitting signal 18 the receiving end.

step 45: According to an information, the receiving end selects a second algorithm to recover the video-transmitting signal 18, wherein the information may be a detection parameter detected by the receiving end itself or may be provided by the transmitting end.

As seen in FIG. 3, since the algorithms used in the image grabber of each manufacturer for converting the original image signal 10 into input signal 12 may be different, the operation complexity of the present invention can be lowered down if the manufacturer provides the algorithm, otherwise, the algorithm is unknown and the image recovered by the second algorithm adapted by the present invention may cause some minor errors. However, the errors are far smaller than the influence caused by the poor communication environment, such that it is negligible.

In an embodiment, the detection parameter is set to be 15% error rate of transmission. When the error rate is smaller than 15%, a common mode is applied for transmission. When the error rate is larger than 15%, a reduction mode is applied for transmission. Comparing with the prior arts using common compress method, the video picture is apparently worsened when the error rate is larger than 20% accord top prior arts, but the present invention may tolerate an error rate up to 50%. Of course, the tolerant relates to the processing speed of a processor; that is, the faster the processor is, then more time is available for resending, and the tolerance is also higher. In the aforesaid embodiment, the capability for resending of the processor is 200 milliseconds per second. If the capability increases to 300 milliseconds per second, the erroneous tolerance will increase by 50%. The higher the tolerance can be, the longer the communication distance may extend. From the aforesaid description, it is known that the error rate of data is proportional to the distance. While the effective distance of traditional compress method is appeared at the error rate of 20%, the present invention may extend the communication distance to where the error rate is 50%, such that the practicability of wireless communication is greatly increased.

In addition, there is another important advantage of the present invention, that is, the present invention is compatible with traditional compress method. Although the objective of the present invention is the same as that of the traditional compress method, but the principle is different, thus, when using the present invention along with a compress method, an addition effect may be received. Therefore, while combining the present invention and the compress method and applying thereof in the aforesaid embodiment, even the error rate reaches 60%, an acceptable picture still may be maintained. That is, when two methods are combined, a better tolerance may be obtained.

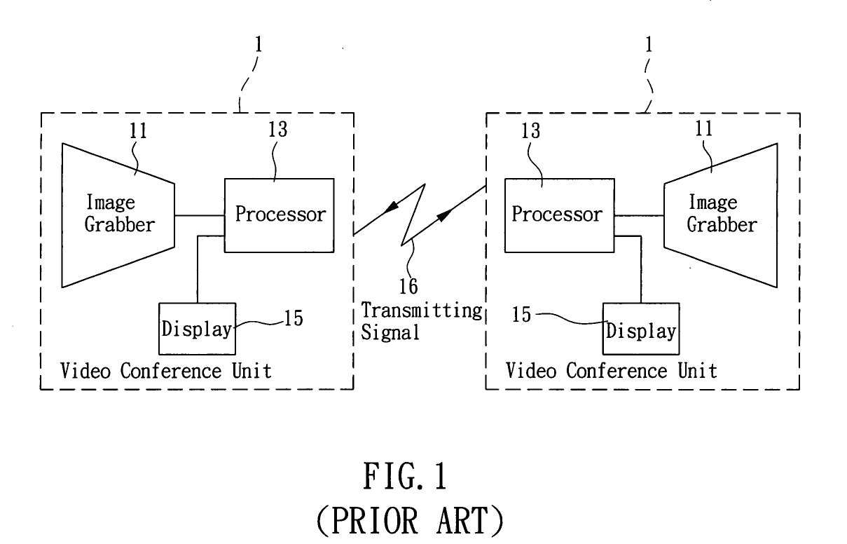

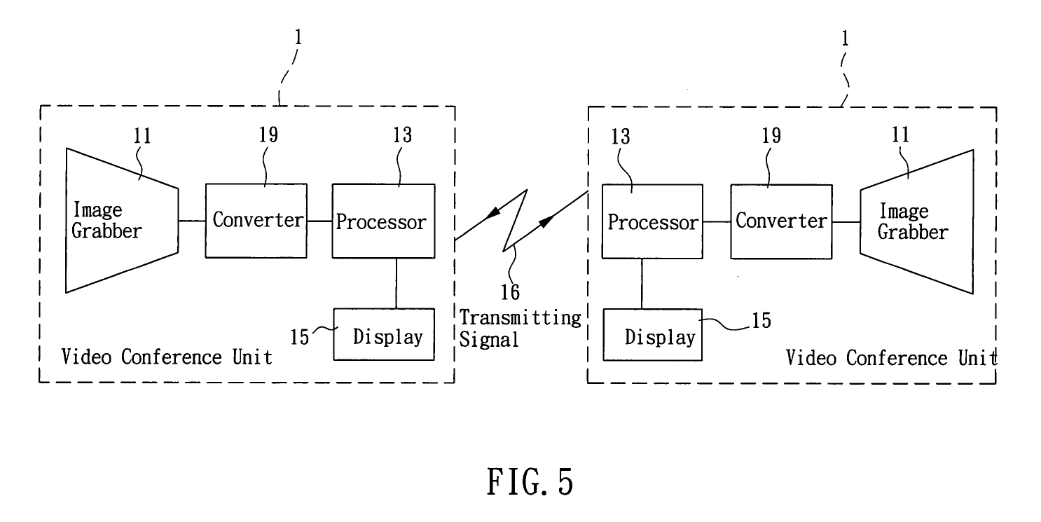

Of course, except for one-directional transmission, the present invention may also be applied in the two-way image transmission with reference to FIG. 1. Please refer to FIG. 5, which is an embodiment showing a wireless framework of a videoconference according to the present invention. Compared with FIG. 1, each set of videoconference unit is added with a first converter 17, which may be connected between the processor 13 and the image grabber 11 or built-in in the processor 13 to assist the process of video.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A system of dynamic video mode switching adapted for wireless transmission, comprising:
a transmitting end having a first converter for receiving a video signal, the first converter transforming the video signal into a video-transmitting signal selectively by a first video mode and a second video mode according to a detection parameter; and
a receiving end having a second converter for receiving the video-transmitting signal and converting the video-transmitting signal into an output video signal, the output video signal being in the first video mode;
wherein the first video mode and the second video mode represent different numbers of still pictures per second.

2. The system of dynamic video mode switching according to claim 1, wherein the video signal is in the first video mode.

3. The system of dynamic video mode switching according to claim 1, wherein the first converter converts the video signal from the first video mode to the second video mode by a first algorithm.

4. The system of dynamic video mode switching according to claim 3, wherein the second converter converts the video-transmitting signal from the second video mode to the first video mode by a second algorithm.

5. The system of dynamic video mode switching according to claim 4, wherein the second algorithm is an inverse function of the first algorithm.

6. The system of dynamic video mode switching according to claim 1, wherein the detection parameter is a transmission error rate.

7. The system of dynamic video mode switching according to claim 6, wherein the first converter uses the first video mode converting the video signal if the transmission error rate is smaller than a threshold.

8. The system of dynamic video mode switching according to claim 6, wherein the first converter uses the second video mode to convert the video signal if the transmission error rate is larger than a threshold.

9. The system of dynamic video mode switching mode according to claim 1, wherein the transmitting end emits a signal to notify the receiving end of mode changing.

10. The system of dynamic video mode switching according to claim 1, wherein the first video mode has 30 sheets of still picture per second and the second video mode has 24 sheets of still picture per second in NTSC (National Television System Committee) system,

11. The system of dynamic video mode switching according to claim 1, wherein the system is compatible with an image compressing method.

12. The system of dynamic video mode switching according to claim 1, wherein the system transmits the video-transmitting signal in both directions.

13. A method for dynamic video mode switching adapted for a wireless video transmission system, comprising the steps of:
according to a detection parameter converting a video signal into a first video signal selectively by a first video mode and a second video mode, wherein the first video mode and the second video mode represent different numbers of still pictures per second;
compressing the first video signal by a first algorithm into a video-transmitting signal;
transmitting the video-transmitting signal.

14. The method to claim 13, wherein the detection parameter is a transmission error rate.

15. The method according to claim 13, wherein the video-transmitting signal includes the detection parameter.

16. The method according to claim 13 further comprising:
receiving the video-transmitting signal;
selecting a second algorithm to converting the video-transmitting signal into an output video signal.

17. The method according to claim 16, wherein the second algorithm is an inverse function of the first algorithm.

18. The method according to claim 16, wherein the output video signal is in the first video mode.
